(19) United States
(12) Patent Application Publication
(10) Pub. No.: US 2026/0192437 A1
(43) Pub. Date: Jul. 9, 2026

(54) CIRCULAR CUTTING TOOL ORGANIZER AND STORAGE DEVICE WITH TAPERED SLOT MECHANISM

(71) Applicant: STEVEN HUNTER RANGEL, SOUTH MIAMI, FL (US)

(72) Inventor: STEVEN HUNTER RANGEL, SOUTH MIAMI, FL (US)

(21) Appl. No.: 19/440,349

(22) Filed: Jan. 5, 2026

Related U.S. Application Data
(60) Provisional application No. 63/741,541, filed on Jan. 3, 2025.

(51) Int. Cl. B25H 3/00

(52) U.S. Cl. CPC B25H 3/003

(57) ABSTRACT

A tool organizer and storage device for automatically sorting substantially cylindrical items by diameter. The device comprises a main body defining a plurality of vertically oriented storage compartments. A sorting plate is positioned on the main body and includes at least one tapered slot that progressively narrows from a wide end to a narrow end. Each storage compartment is aligned with a unique position along the tapered slot. A user inserts an item into the wide end and slides it along the slot until its movement is stopped where the slot width corresponds to the item's diameter. This aligns the item with its designated compartment for storage. At least one deployable holder is pivotally coupled to the main body via a pivot assembly and is movable between a closed position to secure items and an open position to provide access. A retention system secures the holder in its positions.

### CROSS REFERENCE TO RELATED APPLICATION

This application claims the benefit of U.S. Provisional Ser. No. 63/741,541 , filed on January 3, 2025 entitled “Circular Cutting Tool Organizer and Storage Device with Tapered Slot Mechanism,” the entire contents of which are incorporated herein by reference.

### FIELD OF THE INVENTION

The present disclosure relates generally to tool organization and storage systems, and more particularly to devices for storing and organizing collections of circular cutting tools, such as drill bits and end mills.

### BACKGROUND

Existing drill bit organizers often rely on simple trays, racks, or boxes with fixed-size holes or compartments. These designs require users to manually locate and insert tools into correctly sized holes or labeled positions. Such systems are slow, prone to error, and offer limited scalability when new tools are added.

Users frequently face disorganization, with tools stored out of order or mixed in containers, leading to time wasted during tool selection and increased risk of losing small or specialty bits. Traditional systems also lack intuitive feedback mechanisms to verify that a tool has been correctly matched to its storage location.

Therefore, there exists a need for a compact, efficient, and user-friendly device capable of automatically sorting circular cutting tools by diameter. Such a device should enable rapid identification, storage, and retrieval of tools, while maintaining secure containment during transport and use.

### SUMMARY

Aspects of the present disclosure are directed to a tool organizer and storage device configured to automatically sort substantially cylindrical items, such as circular cutting tools like drill bits and end mills, by their diameter. The device provides a compact, efficient, and user-friendly solution for organizing, storing, and retrieving tools, while maintaining secure containment during transport and use.

In one embodiment, the device comprises a main body that defines a plurality of vertically oriented storage compartments. A sorting plate is positioned above these compartments and includes at least one tapered slot characterized by a width that progressively narrows from a first, wider end to a second, narrower end. In a key structural and functional relationship, each storage compartment is aligned with a unique position along the length of the tapered slot. This configuration allows a tool to be inserted into the wide end and slid along the slot until its movement is arrested at a position where the slot width corresponds to the tool's diameter, thereby automatically aligning the tool with its designated storage compartment for placement therein.

In some embodiments, the device further comprises at least one deployable holder operatively and pivotally coupled to the main body. The deployable holder is movable between a closed position, where it secures the tools within the storage compartments, and at least one open position that provides user access to the stored tools. To enhance functionality, the deployable holder may be configured for multiple distinct open positions, including a primary open position for routine access and a secondary open position that provides extended access for maintenance, such as retrieving dropped items or cleaning the compartments. The deployable holder is coupled to the main body via a pivot assembly defining an axis of rotation, and its position is secured by a separate retention system. In further embodiments, the retention mechanism and pivot assembly coupling the holder to the main body may be configured to allow for the complete removal of the holder.

To secure the deployable holder in one or more of its positions, a retention system may be employed. In one embodiment, the retention system comprises at least one magnet disposed on one of the main body or the deployable holder, and a corresponding ferromagnetic material disposed on the other of the main body or the holder, such that magnetic attraction secures the holder. In another embodiment, the retention mechanism comprises a protruding detent formed on one of the main body or the holder, which is configured to resiliently engage at least one corresponding recess formed within the retention channel. In yet another embodiment, the retention system may comprise a spring-loaded latch mechanism to provide a positive mechanical lock. This mechanism includes a latch assembly disposed on one of the main body or the deployable holder, and at least one corresponding keeper disposed on the other. The latch assembly comprises a movable latch member urged by a biasing element, such as a spring, toward an engaged position. The latch member is configured to automatically engage the keeper when the holder reaches a designated position, thereby securely locking it in place. A user-actuatable release is also included, which, when activated, retracts the latch member against the force of the biasing element, disengaging the lock and permitting the holder to be repositioned.

To enhance versatility, the device may be configured for modularity. In certain embodiments, the sorting plate may be removably attached to the main body, allowing a user to install different sorting plates to accommodate various tool size ranges, such as metric or imperial sets. Additionally, the plurality of storage compartments may be formed by a removable insert dimensioned for receipt within the main body. The tapered slot itself may be configured with a stepped or curvilinear profile in addition to a linear taper. In yet another embodiment, the main body may be configured as a dual-sided unit, with each side having a respective sorting plate and storage compartments configured for a different range of tool diameters. To further enhance performance, the tapered slot may be treated with a low-friction coating, and the sorting plate may include visual size indicators positioned adjacent to the slot. The device may be fabricated from a variety of materials, including injection-molded plastics such as ABS or polycarbonate, or aluminum for strength. In a preferred embodiment, the main body, including its internal divider walls and support plates, is formed as a single, unitary molded piece.

Further aspects of the disclosure are directed to a method of organizing substantially cylindrical items. The method comprises the steps of: providing a storage device as described herein; inserting a substantially cylindrical item into the first, wider end of the tapered slot; sliding the item along the tapered slot until movement of the item is arrested at a position where the width of the slot corresponds to a diameter of the item; and placing the item from the sorting plate into a corresponding storage compartment aligned with the position. The method may further comprise pivoting a deployable holder from a closed position to an open position to access the stored item.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The invention can be better understood with reference to the following drawings and description. The components in the figures are not necessarily to scale, emphasis instead being placed upon illustrating various preferred embodiments of the invention.

FIG. 1 is a perspective view of the tool organizer device in a closed position, showing the main body and the deployable holder for large-diameter tools, in accordance with an embodiment of the present disclosure;

FIG. 2 is a perspective view of the device of FIG. 1, showing the large-diameter tool holder in a primary open position to provide access to stored tools, in accordance with an embodiment of the present disclosure;

FIG. 3 is a perspective view of the device of FIG. 1, showing the large-diameter tool holder in a secondary open position to provide extended access to the internal storage compartments, in accordance with an embodiment of the present disclosure;

FIG. 4 is a perspective view of the opposite side of the device, showing the small-diameter tool holder in a closed position, in accordance with an embodiment of the present disclosure;

FIG. 5 is a perspective view of the small-diameter tool holder in a primary open position, in accordance with an embodiment of the present disclosure;

FIG. 6 is a perspective view of the small-diameter tool holder in a secondary open position, in accordance with an embodiment of the present disclosure;

FIG. 7 is a top-down plan view of the sorting plates, illustrating a first step of the sorting process where a tool is inserted into the wide end of a tapered slot, in accordance with an embodiment of the present disclosure;

FIG. 8 is a top-down plan view of the sorting plates, illustrating a second step of the sorting process where tools are at their respective stopping points within the tapered slots, in accordance with an embodiment of the present disclosure;

FIG. 9 is an isometric view illustrating a first action in the sorting process, showing a tool being inserted into the wide end of a tapered slot, in accordance with an embodiment of the present disclosure;

FIG. 10 is an isometric view illustrating a second action in the sorting process, showing the tool having slid to its designated stopping point, in accordance with an embodiment of the present disclosure;

FIG. 11 is an isometric view illustrating a final action in the sorting process, showing the tool being placed into its corresponding storage compartment, in accordance with an embodiment of the present disclosure;

FIG. 12 is a top-down plan view of the tool organizer device in a fully closed configuration, showing the first and second sorting plates, in accordance with an embodiment of the present disclosure;

FIG. 13 is a perspective view of the small-diameter side of the device with the second deployable holder removed to illustrate the internal structure of the small-diameter side without tools, in accordance with an embodiment of the present disclosure;

FIG. 14 is a front view of the small-diameter side of the device with the second deployable holder removed to illustrate the internal structure of the small-diameter side with tools stored, in accordance with an embodiment of the present disclosure;

FIG. 15 is a perspective view of the large-diameter side of the device with the first deployable holder removed to illustrate the internal structure of the large-diameter side without tools, in accordance with an embodiment of the present disclosure; and

FIG. 16 is a front view of the large-diameter side of the device with the first deployable holder removed to illustrate the internal structure of the large-diameter side with tools stored, in accordance with an embodiment of the present disclosure.

### DETAILED DESCRIPTION OF THE EMBODIMENTS

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents.

It should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

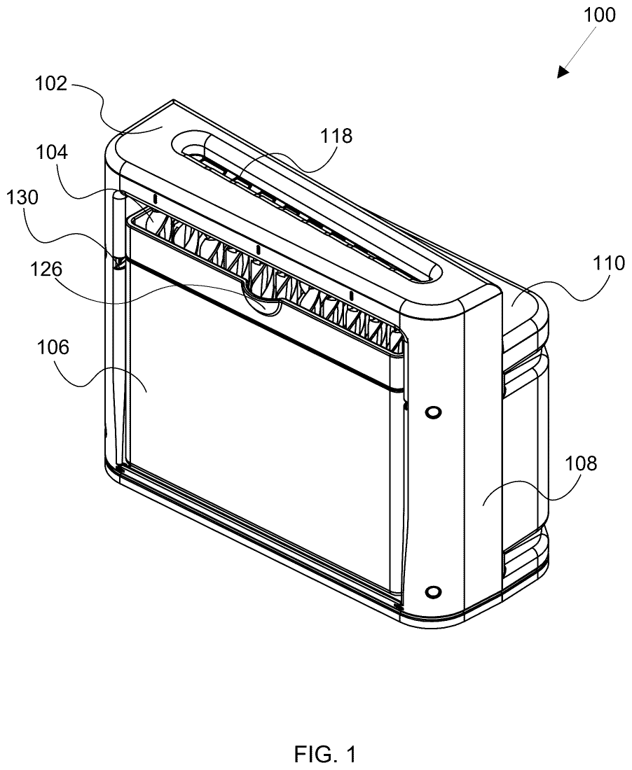

Referring now to FIG. 1, a perspective view of an embodiment of the tool organizer and storage device 100 is shown in its fully closed and secured configuration. This configuration is compact and suitable for transport and storage. The device 100 comprises a main body 108, which serves as the primary housing and structural frame.

Positioned on the upper surface of the main body 108 is a first sorting plate 102, which includes a first tapered slot 118 for sorting larger diameter tools. Adjacent to the first sorting plate 102, a second sorting plate 110 is also visible, illustrating the dual-sided nature of the device.

A first deployable holder 106 is shown in its closed position, operatively coupled to the main body 108. A retention channel 130, which facilitates the positional locking and guidance of the holder 106, is visible along the side of the main body 108. In this closed state, the first deployable holder 106 covers the internal storage compartments (not visible in this view) to securely retain the large circular cutting tools 104 housed within. The holder 106 is configured with openings that allow the ends of the large circular cutting tools 104 to remain partially visible, providing the user with a quick visual inventory of the device's contents. These openings may be shaped to permit splayed visual access to the tool ends, enhancing their individual visibility. A first handle 126 is integrated with the first deployable holder 106 to aid the user in opening and closing the holder.

In an alternative embodiment, to enhance modularity and versatility, the storage compartments may be formed by a removable insert. Such an insert would comprise a base and a plurality of upstanding dividers, configured to slide into and out of the cavity of the main body 108. This configuration allows a user to easily interchange different inserts to accommodate various tool size ranges, such as metric or imperial sets, or to replace a damaged insert without replacing the entire device. This modular approach significantly enhances the serviceability and adaptability of the organizer. While described primarily with respect to circular cutting tools 104, the device 100 is suitable for organizing any substantially cylindrical or elongated items, including but not limited to drill bits, end mills, reamers, hex keys, punches, and hex or square drivers.

Positioned on the upper surface of the main body 108 is a first sorting plate 102. This sorting plate 102 is specifically configured for sorting larger diameter tools and features a first tapered slot 118 that enables the automatic, size-based sorting of the tools. While the slot 118 is shown with a linear taper, it is understood that the slot may be configured with any progressively narrowing profile, including but not limited to a stepped profile defining discrete stop positions, a curvilinear profile, and other configurations.

A first deployable holder 106 is shown in its closed position, operatively and pivotably coupled to the main body 108. In this closed state, the first deployable holder 106 covers the openings of the storage compartments on one side of the device 100, securely retaining the large circular cutting tools 104. In a preferred embodiment, large cutting tools 104 are classified as tools having an outer diameter greater than 0.5 inches. In other embodiments, cutting tools 104 may not be circular such as hex bits, square drivers, or router bits. In other embodiments, the first deployable holder 106 may be shaped and sized to fit cutting tools 104 less than or greater than 0.5 inches.

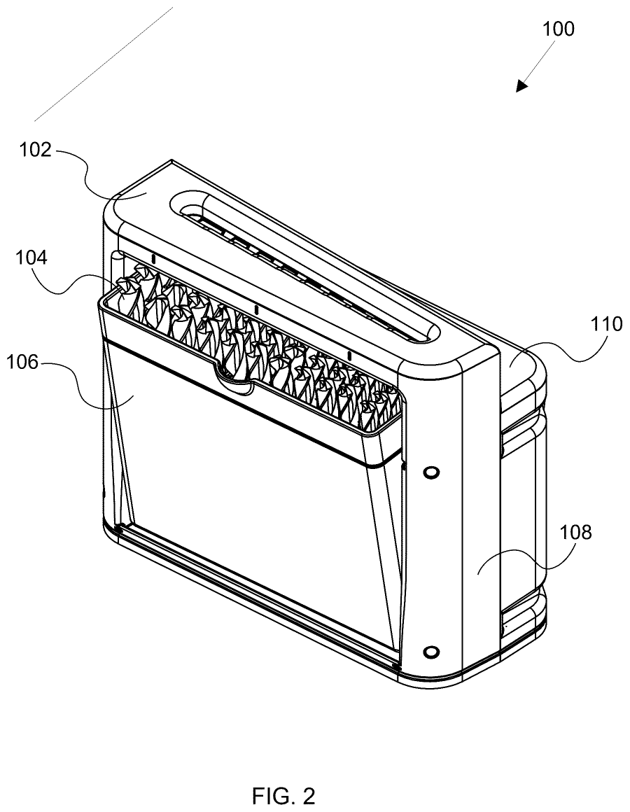

FIG. 2 illustrates a perspective view of the device 100 with the first deployable holder 106 pivoted into its primary open position. This position represents the standard configuration for routine access to tools. In this state, the first deployable holder 106 has pivoted outward from the main body 108, revealing the underlying storage compartments and providing a user with direct access to the large circular cutting tools 104.

The tools 104 are shown seated vertically in their individual compartments, organized and ready for selection. The primary open position is defined by a specific angle that is intentionally designed to present the tools 104 for easy grasping by the user, while also being sufficiently upright to prevent them from being accidentally dislodged during normal use. The first sorting plate 102 and second sorting plate 110 remain visible on the upper surface of the main body 108. This view demonstrates the transition from the secure storage configuration of FIG. 1 to the functional access configuration for tool retrieval.

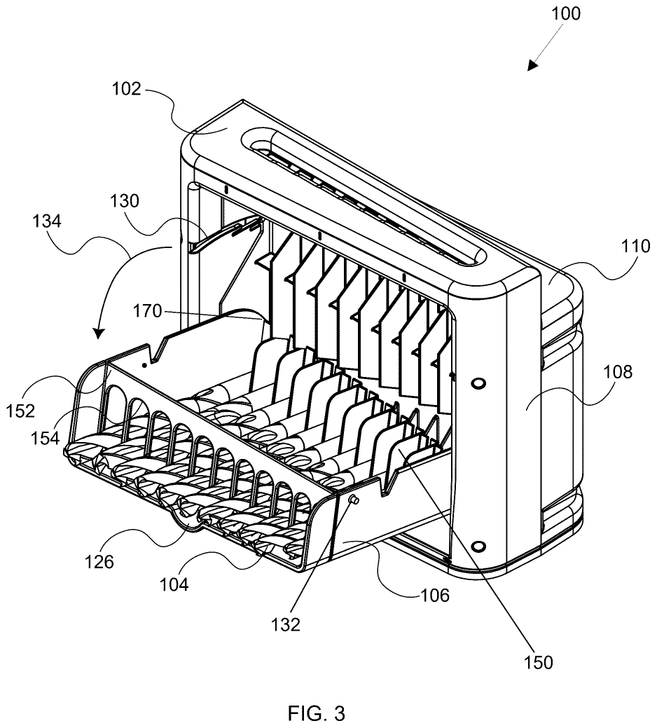

FIG. 3 depicts the device 100 with the first deployable holder 106 pivoted into its secondary open position, as indicated by arrow 134. This position provides a greater range of motion compared to the primary open position shown in FIG. 2, allowing for complete and unobstructed access to the full depth of the internal storage compartments within the main body 108.

The position of the first deployable holder 106 is secured by the interaction between a retention channel 130, formed in the side of the main body 108, and a retention mechanism 132, disposed on the first deployable holder 106. The retention mechanism 132, such as a pin or resilient detent, is configured to be received by and travel within the retention channel 130. The retention channel 130 may include one or more locking features, such as recesses or notches, that engage the retention mechanism 132 to securely hold the deployable holder 106 in a plurality of positions, including the closed position (FIG. 1), a primary open position (FIG. 2), and a secondary open position (FIG. 3). To move the holder, a user applies sufficient force to disengage the retention mechanism 132 from a locking feature, allowing it to travel along the channel 130 until it engages the next locking feature. The interaction between the retention mechanism 132 and the retention channel 130 allows for multiple modes of operation. In certain embodiments, the retention channel 130 may include one or more detents or profiles that engage with the retention mechanism 132 to act as a lock, thereby securely holding the first deployable holder 106 in its various positions, such as the primary or secondary open positions. In further embodiments, the holder 106 may be completely removed from the main body 108 for enhanced cleaning, maintenance, or replacement. In such a configuration, the pivot assembly 170 may be configured to allow for disengagement, for example, by allowing a hinge pin or other securing means to be lifted out of an open-topped hinge receptacle when the holder 106 is rotated to a specific angle, such as the secondary open position. The view clearly exposes the internal structure of the first deployable holder 106, which includes a compartment tray 152 and a plurality of holder divider walls 150. These walls form distinct tray storage slots 154 designed to cradle and support the large circular cutting tools 104 when the holder is closed. The first handle 126 is also visible on the exterior of the holder 106. The pivotal connection between the first deployable holder 106 and the main body 108 is provided by a pivot assembly 170. In a preferred embodiment, the pivot assembly 170 is located at a lower portion of the device and may comprise a hinge pin extending from a bottom edge of the deployable holder 106 and a corresponding hinge receptacle formed in the main body 108. This arrangement defines a fixed axis of rotation, allowing the deployable holder 106 to rotate freely relative to the main body 108 between its closed and open positions. In an alternative embodiment where the holder is fully removable via sliding, the fixed pivot assembly 170 may be omitted. Instead, the pivotal connection is provided by a sliding pivot mechanism located at the bottom of the holder, which travels within a corresponding track in the main body. This track may include an open end, allowing the sliding pivot mechanism to be disengaged from the track, thereby enabling the complete removal of the holder from the main body.

Distinct from the primary open position intended for routine tool access, this secondary open position is specifically designed for maintenance functions. For example, it allows a user to easily retrieve any circular cutting tools 104 that may have been inadvertently dropped behind the holder or to clear out accumulated debris from the bottom of the main body 108. This feature ensures that no tools are permanently lost within the housing and that the device 100 remains fully operational and clean over its lifetime. The first sorting plate 102 and second sorting plate 110 remain positioned on the upper surface of the device.

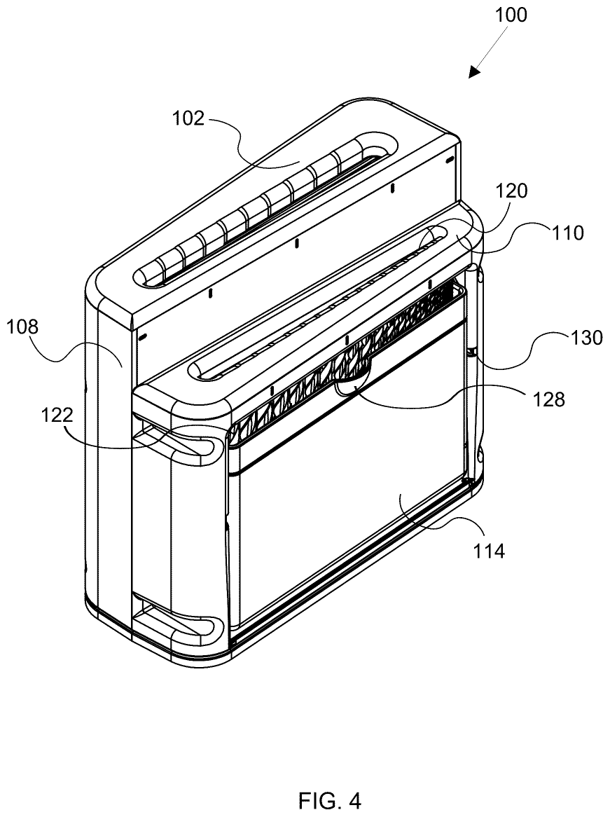

FIG. 4 presents a perspective view of the opposite side of the device 100, illustrating its dual-sided design. This side is specifically configured for organizing and storing smaller diameter circular cutting tools and is shown in a fully closed and secured configuration, analogous to the state depicted in FIG. 1.

A second sorting plate 110, featuring a second tapered slot 120, is positioned on the upper surface of the main body 108. Adjacent to the second sorting plate 110, the first sorting plate 102 is also visible. A second deployable holder 114 is shown pivoted into its closed position. In this state, the second deployable holder 114 securely covers the internal storage compartments, retaining the smaller circular cutting tools 122. Similar to the first holder, openings in the second deployable holder 114 allow portions of the smaller circular cutting tools 122 to remain visible, facilitating quick visual identification of the contents.

In a preferred embodiment, small cutting tools 122 are classified as tools having an outer diameter less than 0.5 inches. In other embodiments, cutting tools 104 may not be circular such as hex bits, square drivers, or router bits. In other embodiments, the second deployable holder 114 may be shaped and sized to fit cutting tools 122 less than or greater than 0.5 inches

A second handle 128 is integrated with the second deployable holder 114 to provide an ergonomic grip for the user. A retention channel 130 is visible on the side of the main body 108, indicating the structural feature that provides for the positional retention of the second deployable holder 114.

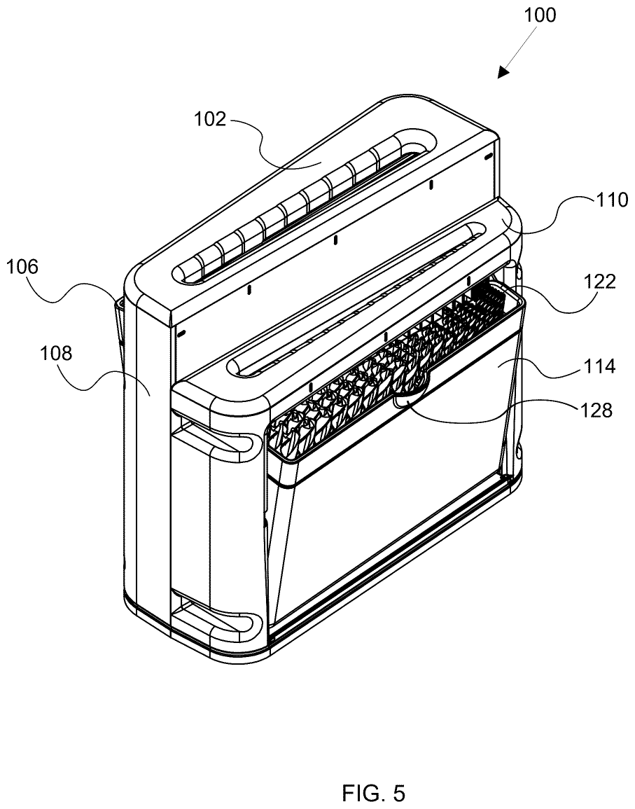

Referring to FIG. 5, a perspective view of the small-diameter side of the device 100 is shown, with the second deployable holder 114 pivoted into its primary open position. This configuration is analogous to the one shown for the larger side in FIG. 2 and represents the standard mode for user interaction and tool retrieval.

In this position, the second deployable holder 114 is pivoted outward from the main body 108 to allow for convenient access to the stored smaller circular cutting tools 122. The tools 122 are shown seated vertically in their respective storage compartments, exposed and ready to be easily grasped by the user for removal. The second handle 128 is visible on the exterior of the second deployable holder 114. For context, the first deployable holder 106 is visible in the background in its closed state, and the first sorting plate 102 and second sorting plate 110 are visible on the upper surface of the main body 108.

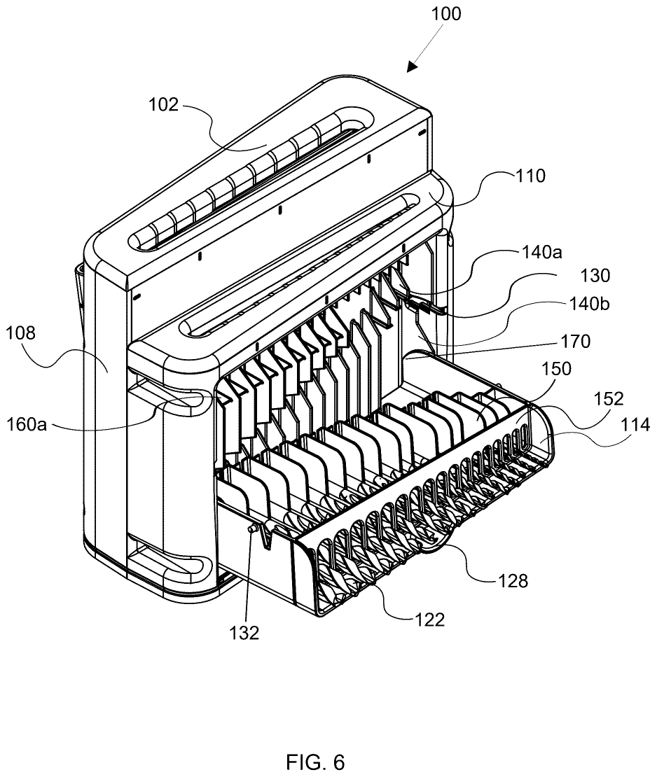

FIG. 6 depicts the small-diameter side of the device 100 with the second deployable holder 114 pivoted into its secondary open position. This action fully exposes the depth of the internal storage compartments within the main body 108, which are formed by a series of integrally molded body divider walls, including a first body divider wall 140a and a second body divider wall 140b. Also visible are the internal support plates, such as 160a, which form the backstops of the compartments. In both the small-diameter and large-diameter sides of the device 100, tools 104, 122 lay against the internal support plates when the holders 106, 114 are in a closed position.

The holder 114 pivots about its pivot assembly 170 to a greater degree than the primary open position shown in FIG. 5. The movement is guided by the retention mechanism 132 traveling within the retention channel 130. The interior of the holder 114 reveals the compartment tray 152 and holder divider walls 150, which are configured to organize and secure the smaller circular cutting tools 122 when the holder is in a closed position.

This extended range of motion is specifically designed for maintenance functions, such as retrieving small-diameter bits that may have fallen to the bottom of the main body 108 or for cleaning the compartments, thereby ensuring complete accessibility and maintainability for the user. The second handle 128 is visible on the holder 114, and the first and second sorting plates (102, 110) remain positioned on the upper surface of the device.

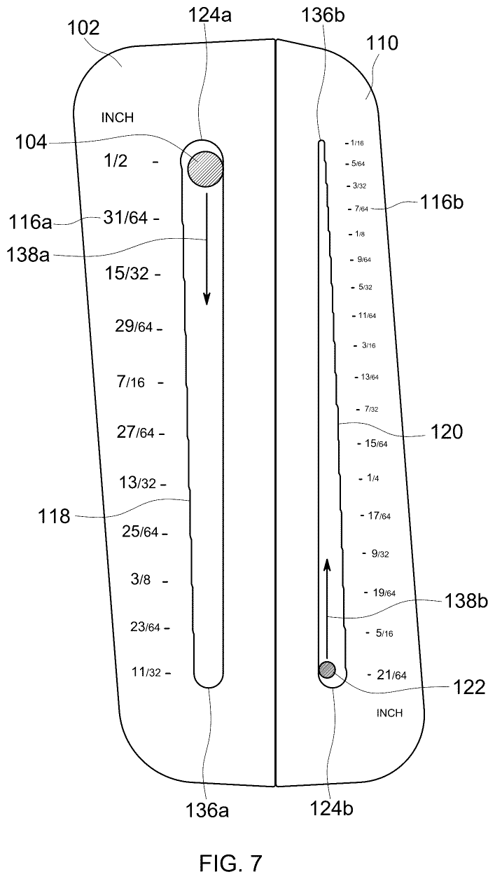

FIG. 7 provides a top-down plan view of the first sorting plate 102 and the second sorting plate 110, illustrating the initial step of the sorting process for both large circular cutting tools 104 and small circular cutting tools 122.

On the left side of the view, a large circular cutting tool 104 is shown inserted into the wide end 124a of the first tapered slot 118 on the first sorting plate 102. The first tapered slot 118 is characterized by a width that progressively narrows from its wide end 124a toward its narrow end 136a. An arrow 138a indicates the intended downward path of travel for the tool 104 along the slot 118. Adjacent to the slot 118, visual size indicators 116a provide markings, such as standard inch measurements, corresponding to tool diameters at various points along the slot's length.

Similarly, on the right side of the view, a smaller circular cutting tool 122 is shown inserted into the wide end 124b of the second tapered slot 120 on the second sorting plate 110. The slot 120 narrows towards its narrow end 136b. An arrow 138b indicates the intended path of travel for the smaller tool 122 along this slot. Visual size indicators 116b are also provided.

This view demonstrates the initial insertion step for both tools, positioning them at the start of their respective tapered slots before they are slid along their length to be automatically sorted by diameter.

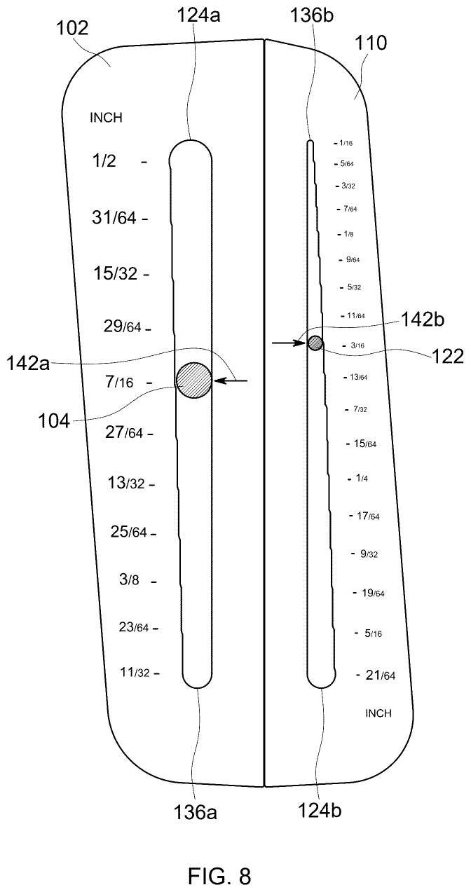

FIG. 8 is a top-down plan view illustrating a subsequent step of the sorting process, following the initial insertion shown in FIG. 7. This view demonstrates how both the large and small circular cutting tools have been guided to their respective stopping points within the tapered slots.

Following its initial insertion, the large circular cutting tool 104 has been slid along the first tapered slot 118 of the first sorting plate 102 until its movement is arrested at its designated stopping point 142a. At this specific position, the width of the tapered slot 118 has narrowed to become equal to the diameter of the tool 104. This action precisely aligns the tool 104 directly above its corresponding storage compartment, completing the horizontal sorting phase for this tool.

In a similar manner, the smaller circular cutting tool 122 has been slid along the second tapered slot 120 of the second sorting plate 110 until it reaches its respective designated stopping point 142b near the narrow end 136b of the slot. At this point, the tool 122 is correctly aligned above its own designated storage compartment. The adjacent visual size indicators (116a, 116b, shown in FIG. 7) further provide confirmation to the user that each tool has been correctly sorted and is ready for placement.

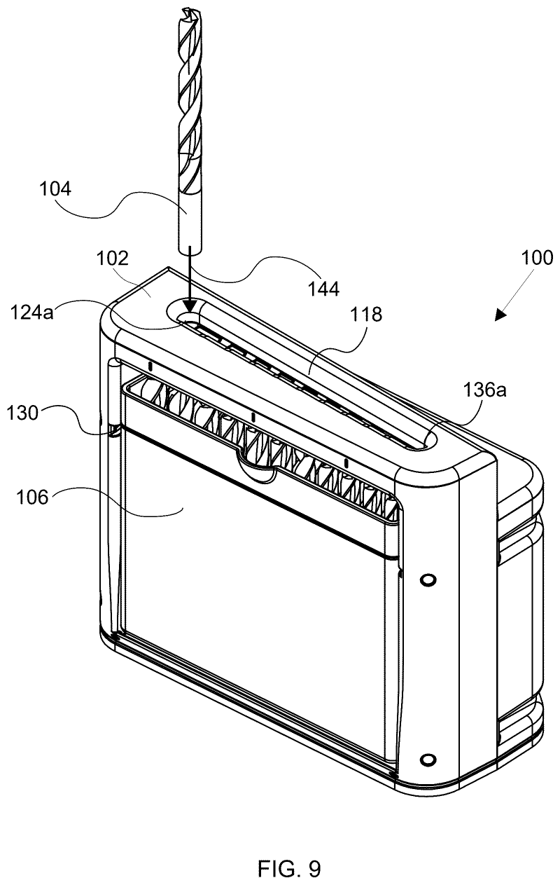

FIG. 9 provides an isometric view illustrating the initial step, or first action, in the sorting process, corresponding to the top-down view shown in FIG. 7. In this view, a large circular cutting tool 104 is shown being inserted, shank-first, into the wide end 124a of the first tapered slot 118, which is located on the first sorting plate 102 of the device 100.

The arrow 144 illustrates the vertical downward motion as the tool 104 is placed into the slot. The wide end 124a is intentionally designed with a broad opening to easily accept tools of various diameters, simplifying the user's initial interaction. The tapered geometry of the slot 118, which progressively narrows towards its narrow end 136a, ensures that the tool 104 remains centered and guided as it begins the sorting operation. The first deployable holder 106 is shown in its closed position, and the retention channel 130 is also visible. This figure effectively captures the user's first physical action in utilizing the device's automatic sorting mechanism.

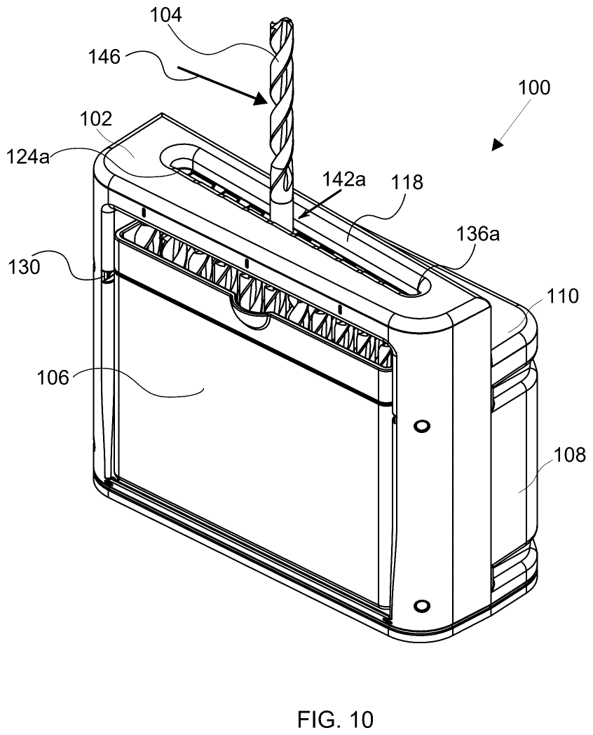

FIG. 10 illustrates the subsequent step in the sorting action, following the initial insertion shown in FIG. 9. As shown, the large circular cutting tool 104 has been guided along the first tapered slot 118, as indicated by the directional arrow 146, until it reaches its designated stopping point 142a.

The designated stopping point 142a is the specific location where the slot's width has narrowed to become equal to the diameter of the tool 104. At this position, the tool 104 is now perfectly aligned above its corresponding storage compartment, ready for the final step of being placed into storage. This action completes the horizontal sorting phase of the operation, having successfully used the tapered geometry of the slot to identify the correct position for the tool based on its size.

The device 100 is shown with its main body 108, first sorting plate 102, second sorting plate 110, and the closed first deployable holder 106. The retention channel 130 and the narrow end 136a of the slot are also visible.

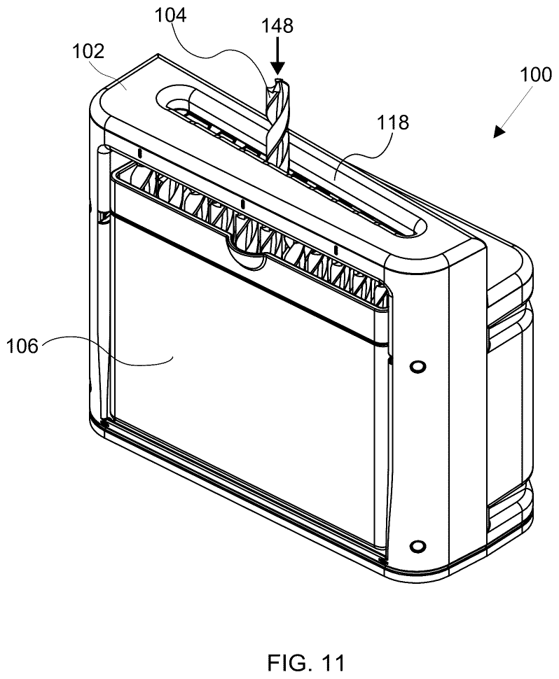

FIG. 11 illustrates the final step in the sorting and storage process, following the alignment of the tool as shown in FIG. 10. Once the large circular cutting tool 104 is positioned at its designated stopping point within the first tapered slot 118 on the first sorting plate 102, the user applies a downward force, as indicated by the arrow 148.

This action moves the tool 104 vertically from the sorting plate 102 into its designated storage compartment, which is housed within the device 100. Upon completion of this step, the tool 104 is securely housed in its correct, size-sorted position, stored vertically and ready for retrieval. This action completes the entire sorting and storage operation for the tool. The first deployable holder 106 is shown in its closed position during this operation. It is to be understood that an analogous operation is performed on the opposite side of the device, wherein a smaller circular cutting tool (122, not shown in this view) is similarly placed from the second tapered slot (120, not shown in this view) into its corresponding storage compartment after being sorted.

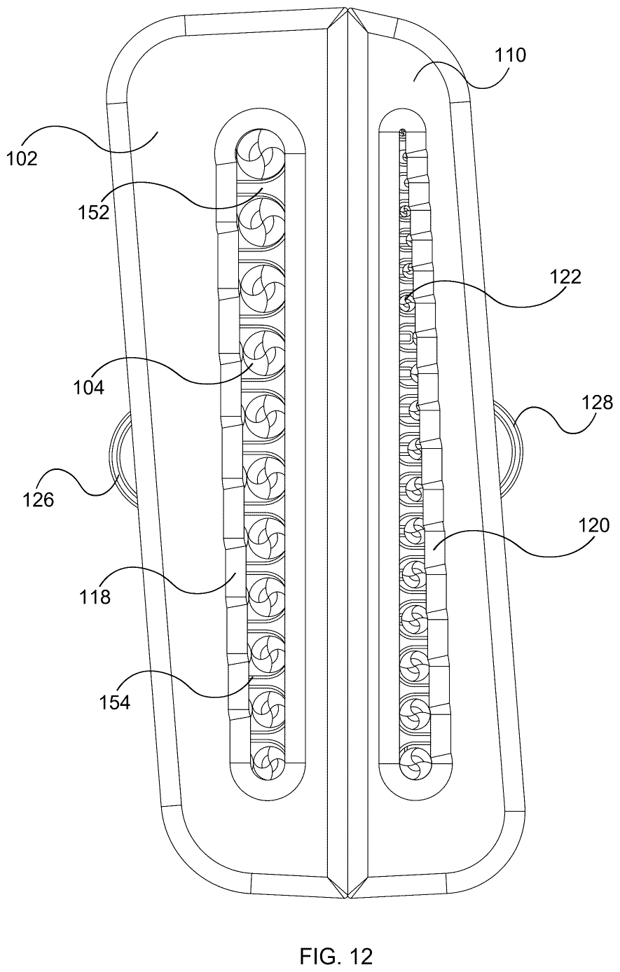

FIG. 12 provides a top-down plan view of the tool organizer device 100, illustrating the device in its fully closed and secured configuration. This view clearly shows the first sorting plate 102 and the second sorting plate 110 positioned adjacently on the upper surface of the main body. The first tapered slot 118 is visible on the first sorting plate 102, and the second tapered slot 120 is visible on the second sorting plate 110.

With the deployable holders in their closed positions, this view looks down upon the stored tools 104, 122. A plurality of large circular cutting tools 104 are shown seated in their compartments on the left side, and a plurality of smaller circular cutting tools 122 are seated on the right side. The tools are visible through the tray storage slots 154, which are formed by the divider walls of the compartment tray 152 of each respective deployable holder. This feature beneficially provides the user with a quick visual inventory of the device's contents without needing to open it.

Also visible are the first handle 126 and the second handle 128, which extend from the sides of the closed deployable holders. This perspective highlights the dual-sided design and the compact, self-contained nature of the device 100 when ready for transport or storage.

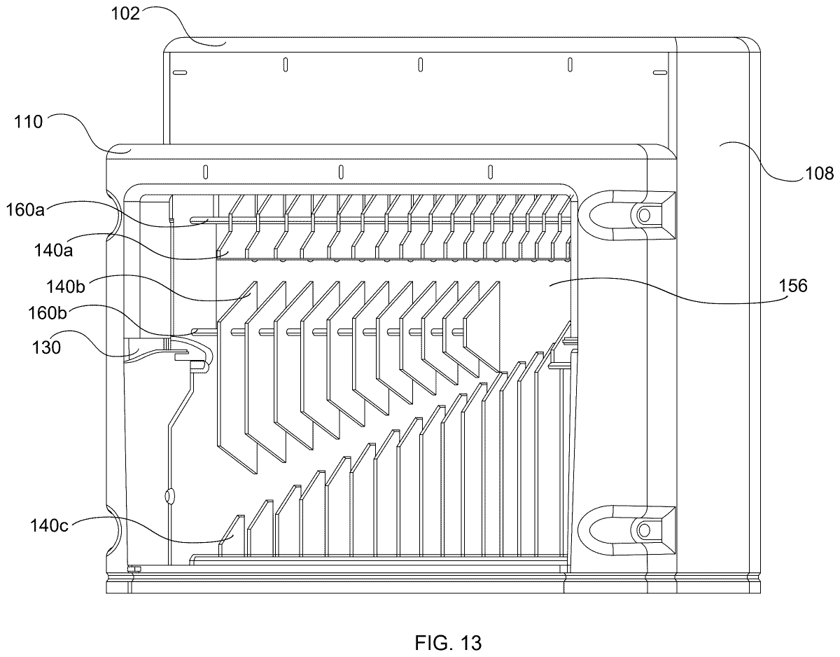

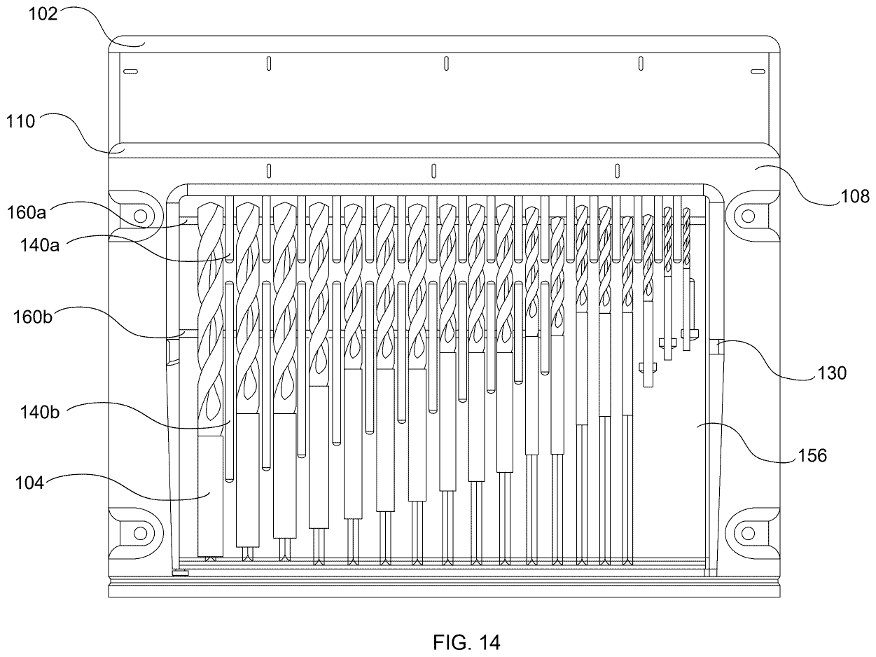

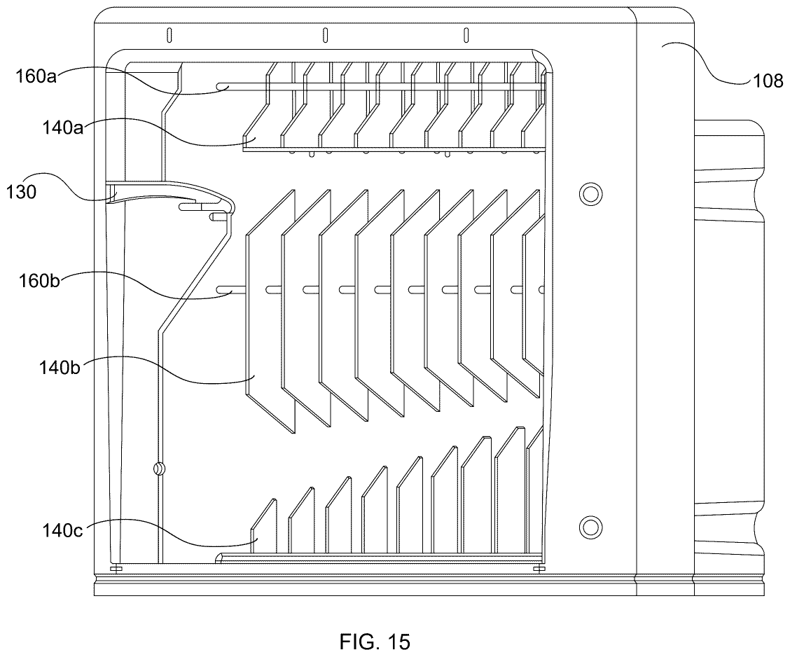

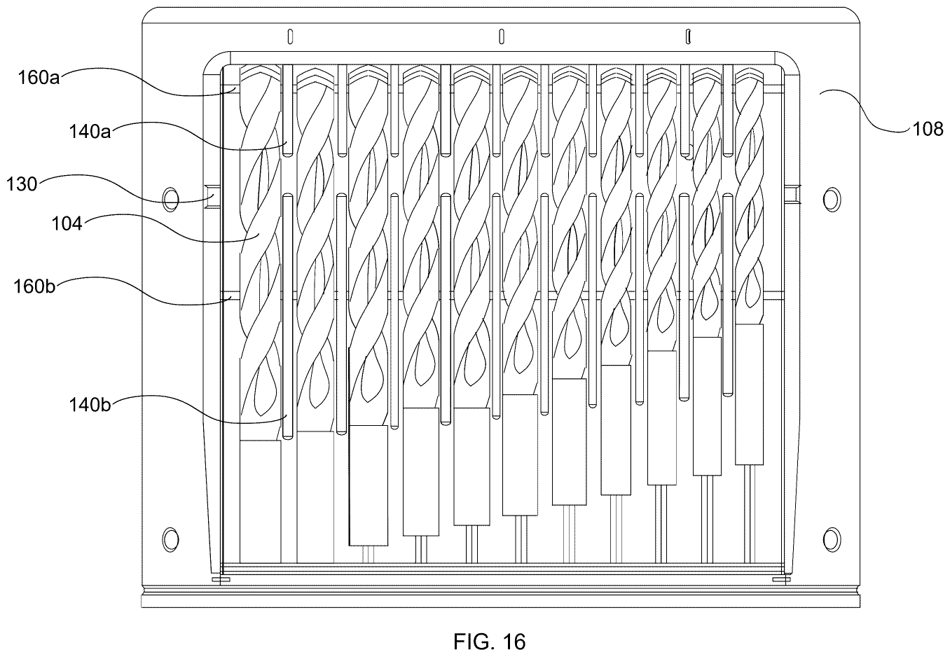

FIGS. 13-16 provide detailed views of the internal storage architecture of the main body 108, with certain external components, such as the deployable holders, removed for clarity. These figures illustrate the storage compartments from perspective views (FIG. 13 13 and 15) and front views (FIGS. 14 and 16). The internal structure is shown both in an empty state to highlight the details of the body divider walls and internal support plates (FIGS. 13 and 15), and in a loaded state with tools seated to demonstrate the final organized arrangement (FIGS. 14 and 16). Collectively, these views detail how the integrally molded features of the main body form the partitioned structure that securely holds and separates the tools.

FIG. 13 a perspective view of the small-diameter side of the device with the second deployable holder removed to illustrate the internal structure of the small-diameter side, and more specifically the storage compartments, without tools stored.

The compartments are formed by a plurality of integrally molded body divider walls, including a first body divider wall 140a, a second body divider wall 140b, and a third body divider wall 140c. In other embodiments, any number of divider walls may be provided. These walls create distinct channels for separating tools. The rear boundary of the compartments is defined by a series of tiered internal support plates (160a, 160b), which extend from the main body back wall 156 and act as backstops for seated tools. The retention channel 130 is also visible, integrated into the side of the main body 108.

The rear boundary of the compartments is defined by a series of tiered internal support plates, including 160a and 160b, which extend from the main body back wall 156. These plates are positioned at different depths and function as backstops to provide vertical support for tools of varying lengths when they are seated in the compartments. The retention channel 130 is also visible, integrated into the side of the main body 108. The outlines indicating the seating area for the first sorting plate 102 and the second sorting plate 110 are also shown on the upper surface of the main body 108.

FIG. 14 is a front view of the small-diameter side of the device with the second deployable holder removed to illustrate the internal structure of the small-diameter side with tools stored, in accordance with an embodiment of the present disclosure. A plurality of large circular cutting tools 104 are shown seated vertically in their respective storage compartments, held in an organized, parallel arrangement by the body divider walls (140a, 140b). The tools rest against the internal support plates (160a, 160b) extending from the main body back wall 156. This configuration ensures each tool is held securely and isolated from adjacent tools. Similarly, smaller cutting tools may be seated in the compartments on the opposite, small-diameter side.

FIG. 15 is a perspective view of the large-diameter side of the device with the first deployable holder removed to illustrate the internal structure of the large-diameter side without tools, in accordance with an embodiment of the present disclosure. This view highlights the plurality of body divider walls (140a, 140b, 140c) and the tiered internal support plates (160a, 160b) that are integrally molded as part of the main body 108. Together, these structural elements form the individual compartments specifically dimensioned for larger diameter tools. Also visible is the retention channel 130, which is integrated into the main body 108 and provides a guide and locking points for the retention mechanism 132 of the first deployable holder.

FIG. 16 is a front view of the large-diameter side of the device with the first deployable holder removed to illustrate the internal structure of the large-diameter side with tools stored, in accordance with an embodiment of the present disclosure. A plurality of large circular cutting tools 104 are shown seated vertically within their respective storage compartments. The tools 104 are held in an organized, parallel arrangement by the body divider walls (140a, 140b) and are supported by the internal support plates (160a, 160b). This view demonstrates how the device's partitioned structure securely maintains the position and separation of each individual large tool, preventing contact and disorganization during storage and transport. The retention channel 130 is also visible.

The main body 108 of the device 100 encloses a plurality of vertically oriented storage compartments, each dimensioned to receive and separate a corresponding substantially cylindrical item. As best shown in FIGS. 14 and 16, which illustrate the internal architecture with the deployable holders removed, these compartments are formed by a series of integrally molded, parallel body divider walls (140a, 140b, 140c) that extend from the main body back wall 156. In a preferred embodiment, the main body 108, including the divider walls and back wall, is formed as a single, unitary molded piece, which provides a rigid and durable organization system.

This partitioned structure creates a series of distinct channels, with each channel defining a single storage compartment. The function of this structure is to ensure that tools (104, 122) are held securely in a vertical orientation and remain isolated from adjacent tools. This separation is beneficial as it prevents contact, damage, and disorganization during transport or storage.

The device is configured with a dual-sided design, comprising a first set of storage compartments on one side specifically dimensioned for storing a first range of item diameters, such as the large circular cutting tools 104, and a second set of storage compartments on the opposite side dimensioned for storing a second, different range of item diameters, such as the smaller circular cutting tools 122.

Furthermore, as seen in FIGS. 14 and 16, the rear of the compartments is defined by a series of internal support plates (160a, 160b). These tiered, horizontal plates act as a backstop, providing vertical support for seated tools of varying lengths and ensuring they are properly positioned within their respective compartments. In some embodiments, the storage compartments themselves may include size markings, for example on an internal wall, to provide further visual confirmation of the stored tool's diameter.

In an alternative embodiment, to enhance modularity and versatility, the plurality of storage compartments may be formed by a removable insert dimensioned for receipt within a cavity of the main body 108. Such an insert would comprise a base and a plurality of upstanding dividers. This configuration would allow a user to easily interchange different inserts to accommodate various tool size ranges, such as metric or imperial sets, or to replace a damaged insert without replacing the entire device. This modular approach significantly enhances the serviceability and adaptability of the organizer.

Additionally, the sorting plates 102, 110 may be removably attached to the main body to enable replacement or adjustment. Alternatively, in another embodiment, the main body 108 and the sorting plates 102, 110 may be integrally molded to form a single, unitary piece, enhancing structural rigidity and simplifying manufacturing. While tapered slots are shown with a linear taper, it is understood that the slot may be configured with any progressively narrowing profile, including but not limited to a stepped profile defining discrete stop positions, or a curvilinear profile.

The device 100 may be fabricated from a variety of materials, including injection-molded plastics such as ABS or polycarbonate for impact resistance, aluminum for strength, or composite materials. In one specific embodiment, the device may feature a hybrid construction wherein the main body incorporates a rigid internal aluminum frame to provide enhanced strength and dimensional stability, while the deployable holders and sorting plates are formed from a durable plastic. Furthermore, the tapered slots may be coated or surface-treated with a low-friction material, such as PTFE, to facilitate smooth sliding of the tool. Although described primarily for circular cutting tools, the device is suitable for organizing any substantially cylindrical or elongated tools, including but not limited to drill bits, end mills, reamers, hex keys, and punches.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. A tool organizer device, comprising:
a main body defining a plurality of storage compartments;
a sorting plate disposed on the main body, the sorting plate including at least one tapered slot having a width that progressively narrows from a first, wider end to a second, narrower end;
wherein each of the plurality of storage compartments is aligned with a unique position along a length of the at least one tapered slot.

2. The device of claim 1, further comprising at least one deployable holder pivotally coupled to the main body, the at least one deployable holder being movable between:
a closed position, wherein the at least one deployable holder secures items within the plurality of storage compartments;
a primary open position providing routine access to the items; and
a secondary open position providing extended access to the plurality of storage compartments.

3. The device of claim 2, further comprising a retention system that secures the at least one deployable holder in at least one of the closed position, the primary open position, or the secondary open position.

4. The device of claim 3, wherein the retention system comprises a retention mechanism on the at least one deployable holder and a retention channel formed in the main body, the retention channel receiving the retention mechanism for movement therein.

5. The device of claim 3, wherein the retention system comprises a mechanism selected from the group consisting of a magnetic latch, a detent mechanism, and a spring-loaded latch.

6. The device of claim 2, wherein the at least one deployable holder includes a plurality of openings that permit visual access to ends of the items when the at least one deployable holder is in the closed position.

7. The device of claim 1, wherein the sorting plate is a first sorting plate including a first tapered slot and the plurality of storage compartments is a first plurality of storage compartments, the device further comprising:
a second sorting plate disposed on the main body, the second sorting plate including a second tapered slot; and
a second plurality of storage compartments defined by the main body, wherein each of the second plurality of storage compartments is aligned with a unique position along a length of the second tapered slot.

8. The device of claim 1, wherein the plurality of storage compartments are arranged in a sequence corresponding to tool diameters from largest to smallest.

9. The device of claim 1, wherein the sorting plate further includes visual size indicators adjacent to the at least one tapered slot.

10. The device of claim 1, wherein at least one of the plurality of storage compartments includes an internal size marking corresponding to a diameter of a tool to be received therein.

11. The device of claim 1, wherein the at least one tapered slot includes a low-friction coating on its surfaces.

12. The device of claim 1, wherein the main body is formed from a material selected from the group consisting of plastic, metal, and a composite material.

13. The device of claim 1, wherein the plurality of storage compartments are formed by a removable insert received within a cavity of the main body.

14. The device of claim 1, wherein the sorting plate is removably attached to the main body.

15. The device of claim 1, wherein the main body and the sorting plate are integrally molded as a single, unitary piece.

16. The device of claim 1, further comprising a plurality of tiered internal support plates extending from a back wall of the main body, the plurality of tiered internal support plates providing vertical support for items of varying lengths seated in the plurality of storage compartments.

17. A method of organizing a substantially cylindrical tool, the method comprising: providing a tool organizer device according to claim 1;
inserting a substantially cylindrical tool into the first, wider end of the at least one tapered slot;
sliding the tool along the length of the at least one tapered slot until movement of the tool is arrested at a stopping position where the width of the at least one tapered slot corresponds to a diameter of the tool; and
placing the tool into the one of the plurality of storage compartments aligned with the stopping position.

18. The method of claim 17, wherein the tool organizer device further comprises a deployable holder pivotally coupled to the main body, the method further comprising: pivoting the deployable holder from a closed position to an open position to access the tool placed in the storage compartment.

19. The method of claim 17, wherein the tool organizer device further comprises a second sorting plate including a second tapered slot and a second plurality of storage compartments aligned therewith, the method further comprising:
inserting a second substantially cylindrical tool into the second tapered slot;
sliding the second tool along the length of the second tapered slot until movement of the second tool is arrested at a second stopping position; and
placing the second tool into one of the second plurality of storage compartments aligned with the second stopping position.

20. The method of claim 17, wherein the one of the plurality of storage compartments is marked with a size corresponding to the diameter of the tool.
